(19) United States
(12) Patent Application Publication
(10) Pub. No.: US 2007/0192763 A1
(43) Pub. Date: Aug. 16, 2007

(54) Method and system for scheduling application of software updates

(76) Inventor: Richard Eric Helvick, Portland, OR (US)

Correspondence Address: SHARP LABORATORIES OF AMERICA, INC., 1320 PEARL ST., SUITE 228, BOULDER, CO, 80302, US

(21) Appl. No.: 11/354,722

(22) Filed: Feb. 15, 2006

(51) Int. Cl. G06F 9/44

(52) U.S. Cl. 717/168

(57) ABSTRACT

Method and system for scheduling application of a software update on a mobile electronic device at a definite time that is convenient for a user. In one aspect, a mobile electronic device comprises a wireless interface adapted to receive a software update, a user interface adapted to receive a scheduling indication from a user and a processor communicatively coupled with the wireless interface and the user interface and adapted to schedule application of the software update on the device at a time determined based on the scheduling indication. In another aspect, a mobile electronic device comprises a wireless interface adapted to receive a software update and a processor communicatively coupled with the wireless interface and adapted to schedule application of the software update on the device at a time determined based on monitored usage of the device.

### BACKGROUND OF THE INVENTION

The present invention relates to scheduling the application of software updates, and more particularly to a method and system for scheduling the application of a software update on a mobile electronic device at a definite but convenient time for a user of such device.

Mobile electronic devices, such as notebook computers, cellular phones, personal data assistants (PDAs) and pocket PCs, are becoming increasingly sophisticated. This increased sophistication has brought with it more complex software and a higher incidence of coding errors, called software bugs. This increased sophistication has also led to more frequent availability of software upgrades that enhance the functionality of such devices. To remove software bugs or enable software upgrades, software updates must be disseminated to and applied on such devices.

To more efficiently disseminate software updates to a large installed base of mobile electronic devices, software update techniques that download code to such devices over-air have been deployed. In such wireless download schemes, a software update is typically loaded on a server in a network infrastructure and is pushed or pulled from the server to a plurality of such devices.

Once a software update has been downloaded to a mobile electronic device, it still must be applied. Application of a software update can be highly disruptive to the user. It often requires power cycling of the device (that is, turning the device off and on) and installation of the software update. The device is typically out of service during the application process, sometimes for several minutes.

In view of these disruptions, some software update techniques provide the user of a mobile electronic device measure of flexibility as to when application of a software update is performed. Some techniques notify the user of a software update and ask the user whether he/she would like to begin application immediately or postpone application. If the user elects to postpone application, some techniques periodically remind the user to apply the software update. These reminders can be an ongoing nuisance to the user and provide no guarantee that the user will ever apply the software update. In other techniques, the user is not reminded and must remember on his/her own to complete application at a later time. These techniques provide even less assurance that the software update will ever be applied to the device.

### SUMMARY OF THE INVENTION

The invention, in a basic feature, provides a software update application method and system that is adapted to schedule application of a software update on a mobile electronic device at a definite but convenient time for a user of such device.

In one aspect, the present invention provides a mobile electronic device comprising a wireless interface adapted to receive a software update, a user interface adapted to receive a scheduling indication from a user and a processor communicatively coupled with the wireless interface and the user interface and adapted to schedule application of the software update on the device at a time determined based on the scheduling indication. The scheduling indication may be selected by the user from one or more proposed times determined on the device and displayed on the user interface. The proposed times may be determined based on monitored usage of the device.

In another aspect, the present invention provides a mobile electronic device comprising a wireless interface adopted to receive a software update and a processor communicatively coupled with the wireless interface and adopted to schedule application of the software update on the device at a time determined based on monitored usage of the device. The scheduled time may be further determined based on a selection made by a user of a proposed time displayed on a user interface communicatively coupled with the processor.

In another aspect, the present invention provides a communication network comprising a server and a mobile electronic device communicatively coupled with the server, wherein the mobile electronic device is adopted to receive a software update from the server and schedule application of the software update on the device at a time determined based on a scheduling indication received from a user of the device.

These and other aspects of the invention will be better understood by reference to the following detailed description taken in conjunction with the drawings that are briefly described below. Of course, the invention is defined by the appended claims.

### BRIEF DESCRIPTION OF THE DRAWINGS

FIG. 1 is a system diagram of a network in accordance with an embodiment of the present invention.

FIG. 2 is a block diagram of a mobile electronic device in accordance with an embodiment of the present invention.

FIG. 3 is a block diagram showing software elements within a mobile electronics device in accordance with an embodiment of the present invention.

FIG. 4 is a flow diagram showing operation of a usage monitor in accordance with an embodiment of the present invention.

FIG. 5 is a flow diagram showing operation of a mobile electronic device in accordance with an embodiment of the present invention.

### DESCRIPTION OF THE PREFERRED EMBODIMENT

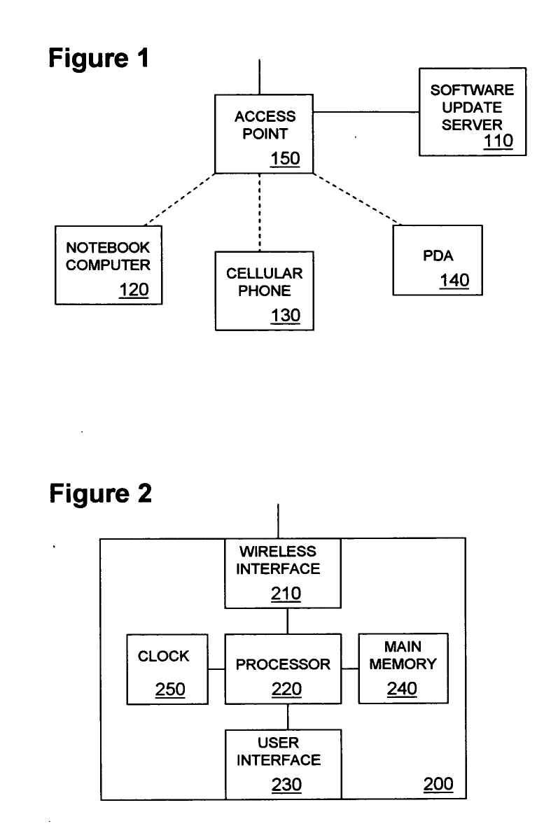

In FIG. 1, a network in accordance with an embodiment of the present invention is shown. The network includes a software update server 110 in a network infrastructure. Server 110 may reside in an enterprise network or a service provider network, for example. Server 110 has wired connectivity with an access point 150, such as a cellular base station or a wireless LAN access point. The connectivity may be direct or via one or more intervening data communication nodes such as routers, switches and bridges. Access point 150 has wireless connectivity with a plurality of mobile electronic devices 120, 130, 140 via respective over-air links. Over-air links may include various types of links over which data may be transmitted, such as a cellular links or an LAN links. Mobile electronic devices 120, 130, 140 shown include a notebook computer 120, a cellular phone 130 and a PDA 140, although other types of devices having a wireless interface, for example pocket PCs, may be deployed. In other embodiments, the mobile electronic devices in the network may be homogenous, that is, all may fit within the same product class (e.g. cell phones).

In a basic feature, software update server 110 stores and distributes software updates to an installed base of mobile electronic devices, such as devices 120, 130, 140. The installed base may include, for example, a group of mobile electronic devices owned by a common enterprise or used by a subscriber group. Software updates may include, for example, patches with corrective code and upgrades with code that supports new features or functionality. In some embodiments, software updates are pulled from server 110 pursuant to requests made by devices 120, 130, 140. In other embodiments, software updates are pushed by server 110 to devices 120, 130, 140 independent of any request.

Turning to FIG. 2, a representative mobile electronic device 200 in accordance with an embodiment of the present invention is shown. Device 200 includes a wireless interface 210 adapted to transmit and receive data in accordance with a wireless communication protocol, such as a cellular or wireless LAN protocol. Device 200 further includes a user interface 230 adapted to transmit outputs and receive inputs from a user of device 200. User interface 230 may, for example, include a display and a mechanism for user input such as a keypad or a touch-sensitive navigation tool. Device 200 further includes a clock 250 adapted to keep current time. In some embodiments, clock 250 is initialized by the network. In other embodiments, device 200 has a GPS receiver and clock 250 is initialized thereby. Device 200 further includes a main memory 240 adapted to store device software and data, such as device settings. Device 200 further includes a processor 220 adapted to execute the device software stored in main memory 240 and interoperate with elements 210, 230, 240 and 250 to perform the various features and functions supported by device 200.

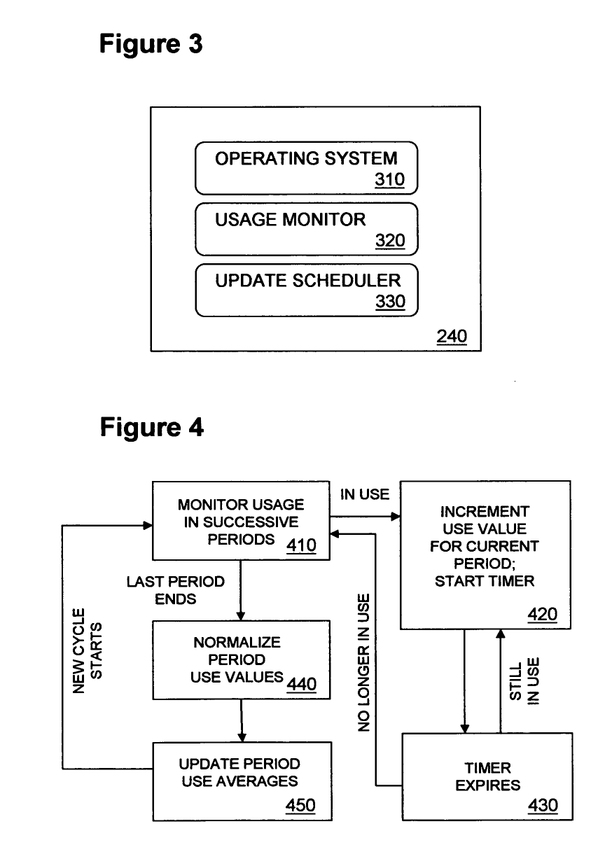

Turning now to FIG. 3, main memory 240 is shown in more detail to include certain device software, including an operating system 310, a usage monitor 320 and an update scheduler 330. Usage monitor 320 is a software program adapted to track time-dependent usage of device 200. More particularly, usage monitor 320, running on processor 220 and interoperating with clock 250, records times of day when device 200 is in use and calculates a usage profile for different times of day based on such records. Update scheduler 330 is a software program adapted to schedule application of a software update on device 200 at a definite but convenient time for a user of device 200. More particularly, update scheduler 330, running on processor 200 and interoperating with usage monitor 320 and user interface 230, determines one or more proposed application times for a software update based on the usage profile created by usage monitor 320, displays such application times on user interface 230, accepts a user-selected application time and schedules application of the software updates on device 200 at the user-selected application time. In other embodiments, update scheduler 330 automatically schedules application of the software update based on the usage profile without consulting the user.

Referring to FIG. 4, a flow diagram shows operation of usage monitor 320 in accordance with an embodiment of the present invention. When a monitoring cycle commences, monitor 320 begins to monitor usage of device 200 starting with the first of a plurality of periods and continuing for each successive period within the cycle (410). A monitoring cycle may commence when the current time from clock 250 conforms to a monitoring cycle start time programmed in monitor 320. In other embodiments, monitoring may be continuously performed. A period within a monitoring cycle is a block of time, for example, an hour within a one-day cycle. Clock 250 may be referenced to determine the current period within the cycle.

Continuing with FIG. 4, when usage monitor 320 detects an in-use event, a use value maintained for the current period is incremented and a timer is started (420). If device 200 is still in use when the timer expires (430), the use value is again incremented and the timer is restarted. If, however, device 200 is no longer in use when the timer expires, usage monitor 320 monitors for a new in-use event (410). It will be appreciated that by incrementing and setting a timer in-loop for as long as device 200 remains in use, a more precise usage profile may be obtained. For example, if a one-minute timer is employed in a cycle having a multiple of one-hour periods, over the cycle the use value for each period will be incremented between zero and 60 times rather than zero or one time as would occur in the absence of a timer.

Continuing further with FIG. 4, when the lost period ends, use values for each period are normalized (440). For each period, a normalized use value is obtained by dividing the use value for the period by the sum of the use values across all periods. Next, normalized use averages for each period are updated (450). For each period, the normalized use value is added to the normalized use values from prior cycles to obtain a normalized use value sum. The normalized use value sum is then divided by the number of cycles to obtain updated normalized use averages for each period.

Applying the above Steps 440 and 450 in an example, consider a twice-completed cycle having three periods of equal duration, wherein in the first cycle the recorded use values [expressed in <use(period1), use(period2), use(period3)> format] are <5, 10, 15> and in the second cycle the recorded use values are <8, 10, 12>. In the first cycle, the normalized use values are <0.167, 0.333, 0.500>. In the second cycle, the normalized use values are <0.267, 0.333, 0.400>, the normalized use value sums are <0.434, 0.666, 0.900> and the updated normalized use averages are <0.217, 0.333, 0.450>. From the updated normalized use averages it follows that over the two cycles, usage of the mobile electronic device was lightest during period one and heaviest during period three, with period two reflecting an intermediate level of usage.

In other embodiments, use values from more recent cycles are given greater weight than those from less recent cycles in determining use averages. In still other embodiments, use values from cycles that are sufficiently stale are not considered.

In-use events may be defined differently for different classes of mobile electronic devices. For example, where the device is a cell phone, an in-use event may be a telephone call, with the device being considered in-use for the duration of the call. Where the device is a notebook computer, an in-use event may be a TCP/IP session, with the device being considered in-use for the duration of the session. More generally, in-use events will be defined by user activity on the mobile electronic device.

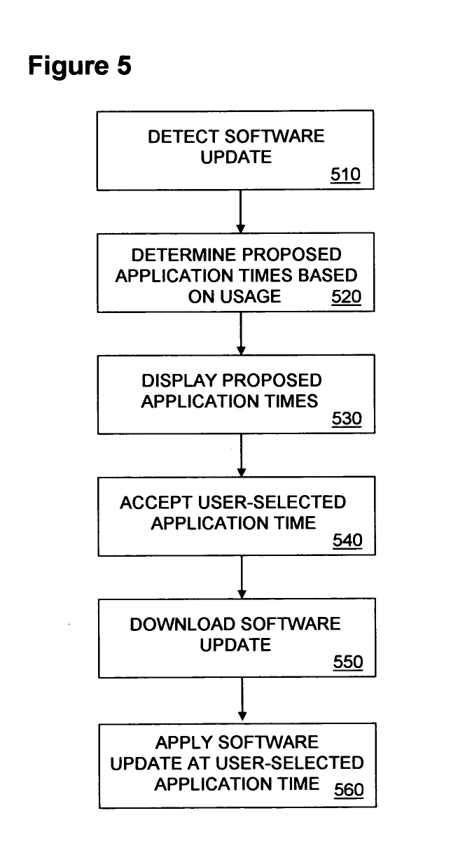

Referring now to FIG. 5, a flow diagram shows operation of mobile electronic device 200 in accordance with an embodiment of the present invention. Update scheduler 330 detects a software update event, for example, detects information concerning an impending software update download from a software update server (510) and determines one or more proposed times for application of the software update based on device usage (520). In particular, update scheduler 330 queries usage monitor 320 and determines one or more periods when device 200 has been least used. Update scheduler 330 then causes the one or more proposed application times to be displayed on user interface 230 in a user-selectable format and prompts the user for a scheduling indication (530). For example, where the mobile electronic device is a cell phone having a touch-sensitive navigation tool, the user screen may present the user with a menu of times rank-ordered based on periods when the device has been least used, with the least used time highlighted by default. The user can then select the default time or maneuver the tool to scroll the menu for a more convenient time. In some embodiments, the user may manually input a time other than those proposed. In any event, update scheduler 330 accepts a valid user selection and schedules application of the software update at the selected time (540). The software update is then downloaded into main memory 240 (550) and, at the scheduled time, is applied to device 200 (560). Application of the software update may involve, for example, power cycling of device 200 and installation of the software update.

In other embodiments, download of the software update occurs earlier in the process flow, for example, concurrently with detection of the software update event. In still other embodiments, update scheduler 330 causes notice of a software update to be displayed on user interface 230 without proposed application times. In these embodiments, the user manually inputs an application time convenient for the user.

It will be appreciated by those of ordinary skill in the art that the invention can be embodied in other specific forms without departing from the spirit or essential character hereof. The present description is therefore considered in all respects to be illustrative and not restrictive. The scope of the invention is indicated by the appended claims, and all changes that come with in the meaning and range of equivalents thereof are intended to be embraced therein.

What is claimed is:

1. A mobile electronic device, comprising:
a wireless interface adopted to receive a software update;
a user interface adapted to receive a scheduling indication from a user; and
a processor communicatively coupled with the wireless interface and the user interface and adapted to schedule application of the software update on the device at an application time determined based on the scheduling indication.

2. The device of claim 1, wherein the scheduling indication is selected by the user from one or more proposed times displayed on the user interface.

3. The device of claim 2, wherein the proposed times are determined on the device.

4. The device of claim 2, wherein the proposed times are determined based on monitored usage of the device.

5. The device of claim 2, wherein the proposed times are determined based on use of the device during a plurality of periods within a monitoring cycle.

6. The device of claim 5, wherein the proposed times include times within periods when the device has been least used.

7. The device of claim 1, wherein the software update is applied on the device at the application time.

8. The device of claim 1, wherein the device comprises a telephone.

9. A mobile electronic device, comprising:
a wireless interface adopted to receive a software update; and
a processor communicatively coupled with the wireless interface and adapted to schedule application of the software update on the device at an application time determined based on monitored usage of the device.

10. The device of claim 9, further comprising a user interface communicatively coupled with the processor and adapted to display one or more proposed times for application of the software update determined based on monitored usage of the device.

11. The device of claim 10, wherein the application time is selected by a user of the device from the proposed times.

12. The device of claim 10, wherein the proposed times are determined based on use of the device during a plurality of periods within a monitoring cycle.

13. The device of claim 12, wherein the proposed times include times when the device has been least used.

14. The device of claim 9, wherein the software update is applied on the device at the application time.

15. The device of claim 9, wherein the device comprises a telephone.

16. A method for application of a software update to a mobile electronic device at a time convenient for a user, comprising the steps of:
receiving a software update;
receiving a scheduling indication selected by a user from one or more proposed times for application of the software update determined based on monitored usage of the device; and
scheduling application of the software update on the device at an application time determined based on the scheduling indication.

17. The method of claim 16, wherein the proposed times are determined based on use of the device during a plurality of periods within a monitoring cycle.

18. The method of claim 1 7, wherein the proposed times include times within periods when the device has been least used.

19. The method of claim 16, wherein the software update is applied on the device at the application time.

20. The method of claim 16, wherein the device comprises a telephone.
